(19) United States
(12) Patent Application Publication
(10) Pub. No.: US 2018/0253736 A1
(43) Pub. Date: Sep. 6, 2018

(54) SYSTEM AND METHOD FOR DETERMINING RESOLUTION FOR AN INCIDENT TICKET

(71) Applicant: Wipro Limited, BANGALORE (IN)

(72) Inventors: Venkatakrishnan RAJARAM, Bengaluru (IN); Priya BISWAS, Kolkata (IN)

(73) Assignee: Wipro Limited

(21) Appl. No.: 15/463,361

(22) Filed: Mar. 20, 2017

(30) Foreign Application Priority Data
Mar. 6, 2017 (IN) 201741007854

(51) Int. Cl. G06Q 30/00; G06N 5/02

(52) U.S. Cl. CPC G06Q 30/016; G06N 5/022

(57) ABSTRACT

This disclosure relates generally to incident ticket management, and more particularly to system and method for resolving incident tickets. In one embodiment, a method is provided for determining a resolution for an incident ticket. The method comprises dynamically determining a signature of the incident ticket based on a description of the incident ticket, and determining a resolution code based on the signature using a knowledge graph model. The knowledge graph model is derived, from a plurality of past incident tickets and a plurality of corresponding resolutions, by determining a set of unique signatures and a set of corresponding resolution codes.

### TECHNICAL FIELD

This disclosure relates generally to incident ticket management, and more particularly to system and method for determining resolution for incident tickets.

### BACKGROUND

Advancements in the field of Information Technology (IT) have enabled digitization of various processes and activities in an industry or an enterprise. However, to derive the benefits of digitization, the IT infrastructure needs to run smoothly. Additionally, an efficient incident ticket management system is required to provide a quick resolution to any user queries or any incident ticket with respect to the IT infrastructure. The incident ticket may include an issue or a problem that a user faces at the hardware and/or software level, or may also include a request for information on the hardware and/or software.

Typically, in an IT support environment, a large volume of incident tickets may be generated that need manual support and involvement for resolution. For example, to apply an appropriate resolution for a problem raised in an incident ticket, one has to map the incident ticket with a correct resolution code, and perform steps provided in the resolution code. However, the association of incident ticket with the appropriate resolution code by manual examination and analysis consumes a substantial amount of manual effort and time, particularly when the volume of incident tickets is large.

Thus, there is a need for automating the process of identifying the resolution code so as to reduce manual efforts and resolution time. A number of existing techniques provide for automation of the same to at least some degree. In most of the existing techniques, the process of mapping an incident ticket with an appropriate resolution code typically involves comparing the activity data of the current ticket with the activity data of past incident tickets (that are already resolved). However, such techniques require storing the activity data of all the past tickets, which in turn consume space.

### SUMMARY

In one embodiment, a method for determining a resolution for an incident ticket is disclosed. In one example, the method comprises dynamically determining a signature of the incident ticket based on a description of the incident ticket. The method further comprises determining a resolution code based on the signature using a knowledge graph model. The knowledge graph model is derived, from a plurality of past incident tickets and a plurality of corresponding resolutions, by determining a set of unique signatures and a set of corresponding resolution codes.

In one embodiment, a system for determining a resolution for an incident ticket is disclosed. In one example, the system comprises at least one processor and a memory communicatively coupled to the at least one processor. The memory stores processor-executable instructions, which, on execution, cause the processor to dynamically determine a signature of the incident ticket based on a description of the incident ticket. The processor-executable instructions, on execution, further cause the processor to determine a resolution code based on the signature using a knowledge graph model. The knowledge graph model is derived, from a plurality of past incident tickets and a plurality of corresponding resolutions, by determining a set of unique signatures and a set of corresponding resolution codes.

In one embodiment, a non-transitory computer-readable medium storing computer-executable instructions for determining a resolution for an incident ticket is disclosed. In one example, the stored instructions, when executed by a processor, cause the processor to perform operations comprising dynamically determining a signature of the incident ticket based on a description of the incident ticket. The operations further comprise determining a resolution code based on the signature using a knowledge graph model. The knowledge graph model is derived, from a plurality of past incident tickets and a plurality of corresponding resolutions, by determining a set of unique signatures and a set of corresponding resolution codes.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram of an exemplary system for determining a resolution for an incident ticket in accordance with some embodiments of the present disclosure.

FIG. 2 is a functional block diagram of an exemplary incident ticket resolution engine in accordance with some embodiments of the present disclosure.

FIG. 3 is a flow diagram of an exemplary process for determining a resolution for an incident ticket in accordance with some embodiments of the present disclosure.

FIG. 4 is a flow diagram of a detailed exemplary process for determining a resolution for an incident ticket in accordance with some embodiments of the present disclosure.

FIG. 5 is a block diagram of an exemplary computer system for implementing embodiments consistent with the present disclosure.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

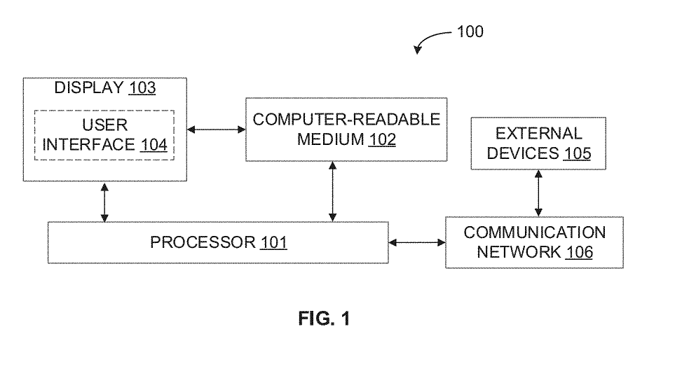

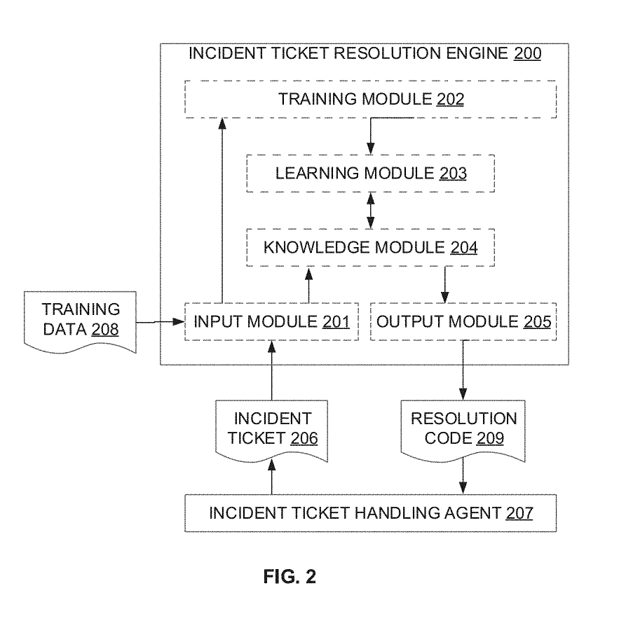

Referring now to FIG. 1, an exemplary system 100 for determining a resolution for an incident ticket is illustrated in accordance with some embodiments of the present disclosure. In particular, the system 100 implements an incident ticket resolution engine to determine a resolution for an incident ticket. As will be described in greater detail in conjunction with FIG. 2, the incident ticket resolution engine comprises multiple modules configured to analyze incident ticket so as to provide appropriate resolution. For example, the incident ticket resolution engine dynamically determines a signature of the incident ticket based on a description of the incident ticket, and determines a resolution code based on the signature using a knowledge graph model. The knowledge graph model is derived, from a plurality of past incident tickets and a plurality of corresponding resolutions, by determining a set of unique signatures and a set of corresponding resolution codes.

The system 100 comprises one or more processors 101, a computer-readable medium (e.g., a memory) 102, and a display 103. The computer-readable medium 102 stores instructions that, when executed by the one or more processors 101, cause the one or more processors 101 to determine a resolution for an incident ticket in accordance with aspects of the present disclosure. For example, the computer-readable medium 102 may store set of instructions corresponding to various modules for deriving a knowledge graph model, determining a signature, determining an appropriate resolution code, and so forth. The one or more processors 101 may fetch the instructions from the computer-readable medium 102 via a wired or wireless communication path, and execute them to resolve incident tickets.

The computer-readable medium 102 may also store various data (e.g., past ticket repository, incident tickets, resolution codes, n-grams, unique signatures, knowledge graph, knowledge graph model, signature, etc.) that may be captured, processed, and/or required by the system 100. The system 100 interacts with a user via a user interface 104 accessible via the display 103. The system 100 may also interact with one or more external devices 105 over a communication network 106 for sending or receiving various data (e.g., training data, incident ticket, resolution code, etc.). For example, the system 100 may receive incident ticket generated from an external device 105 and provide appropriate resolution for the incident ticket to the external device 105. Again, as will be described in greater detail in conjunction with FIG. 2, the external device 105 implements an incident ticket handling agent to send the incident ticket to the system 100, and to receive appropriate resolution for the same from the system 100. The external devices 105 may include, but are not limited to, a desktop system, a remote server, a digital device, or any other computing system.

Referring now to FIG. 2, a functional block diagram of an incident ticket resolution engine 200 implemented by the system 100 of FIG. 1 is illustrated in accordance with some embodiments of the present disclosure. The incident ticket resolution engine 200 may include various modules that perform various functions so as to determine and provide relevant resolution to incident ticket. In some embodiments, the incident ticket resolution engine 200 comprises an input module 201, a training module 202, a learning module 203, a knowledge module 204, and an output module 205.

The input module 201 receives one or more incident tickets 206 (e.g., service request, user query, etc.) from a computing system. The summary of the problem may be provided in the description of the incident ticket 206. In some embodiments, the incident tickets 206 may be generated from the incident ticket handling agent 207 residing within the computing system (e.g., desktop system) as an application. Additionally, the input module 201 receives training data 208 from one or more sources (e.g., a user, another computing system, etc.). The training data 208 enables the incident ticket resolution engine 200 to build a knowledge graph model for providing an appropriate resolution code for the incident ticket 206 received from the incident ticket handling agent 207. The training data 208 may include a repository or a dump of data related to past incident tickets and corresponding resolutions. In some embodiments, it may be in the form of comma-separated values (CSV) file or Microsoft excel file and may include a number of fields or parameters such as a ticket ID or ticket number, a primary application, a title, a ticket description or a problem description, a resolution category, a resolution description, and so forth. In some embodiments, the ticket repository may include incident tickets from past two, three, or six months and corresponding resolutions.

The training module 202 stores the training data 208 received by the input module 201. Additionally, the training module 202 in conjunction with the learning module 203 uses the training data 208 to learn about different incident tickets and their corresponding resolutions. For example, the training module 202 feeds the training data 208 into the learning module 203 which trains to build a knowledge graph based on the training data 208. The knowledge graph stores as many possible combinations of unique signatures and their corresponding resolution codes. Each of the unique signatures may correspond to a unique problem type in the past incident tickets.

The learning module 203 analyzes the past incident tickets and determines multiple sets of incident tickets corresponding to unique problem types. In other words, the past incident tickets may be grouped in multiple sets of incident tickets such that each set corresponds to a unique problem type being addressed in the tickets. The learning module 203 then determines unique signature for each of the multiple sets (i.e., unique problem type). Thus, in some embodiments, each of the unique signatures may correspond to an identified type of recurring incidents (i.e., identified recurring problem type) in the past incident tickets. Additionally, the learning module 203 identifies resolution code for each of the multiple sets based on the resolutions associated with the incident tickets in the set. Each resolution code may be associated with a set of commands to be performed so as to resolve the incident tickets belonging to a given set. Finally, the learning module 203 maps the unique signatures with the corresponding resolution codes so as to build the knowledge graph. Each of the unique signatures may be represented as a unique path in the knowledge graph along with the corresponding resolution code at the leaf node. The knowledge graph with unique signatures representing different unique problem types along with the resolution codes at leaf nodes may then be deployed in client environment to uniquely identify the resolution code of an incoming ticket.

In some embodiments, the learning module 203 determines the unique signature for each of the multiple sets by pre-processing the descriptions of the incident tickets in the set, determining n-grams and corresponding weightages from the pre-processed descriptions, and selecting one of the n-grams as the unique signature based on the assigned weightage. In some embodiments, the pre-processing may include, but is not limited to, removing URLs, removing numbers, removing generic stop words, removing custom stop words, removing Emails, removing special characters, removing date and time values, removing punctuations, and so forth as they have little or no contribution to content, context, and meaning of the ticket. Further, in some embodiments, the pre-processing may involve extracting the specific information needed from Form based or Email based patterns.

The term n-grams refers to continuous sequence of ‘n’ words in a given structured or semi-structured description and effectively enable the identification of error symptom (i.e., problem type) in the incident ticket. In some embodiments, the n-grams may include at least one of unigrams (1 word sequence), bigrams (2 words sequence), and trigrams (3 words sequence). The n-grams may be determined based on a value of ‘n’ and a frequency of terms in the description. The value of ‘n’ may be pre-defined or may be provided by the user.

By way of example, in some embodiments, an exemplary incident ticket description and corresponding unique signature is provided in Table A below:

TABLE A

| | |
|---|---|
| Description | SQLErrors Alert from ABCDE SERVER DB_Alert_C Polltime |
| | =Sunday - January 10 2016 08 19 06_{——}Error=_{——}Alert Value=Error ID |
| | 11 Error # 99 Severity 99 State 99 Procedure usp_RecoverEOD |
| | Line 99 Msg Replication Down or Triggers Missing Time Jan 10 |
| | 2016 6 17AM_{——}TrapNumber=1_{——}TrapCount=1 |
| Signature | sqlerrors usp recovered replication triggers missing |

The knowledge module 204 derives a knowledge graph model based on the knowledge graph received from the learning module 203. The knowledge graph model may then be leveraged to infer right resolution code 209 for an incoming incident ticket 206 that may be executed for resolving the incoming incident ticket 206. The knowledge module 204 dynamically determines a signature for an incoming incident ticket 206 based on the problem type as obtained from the description of the incoming incident ticket 206. The knowledge module 204 then maps the signature with an existing unique signature using the knowledge graph model so as to determine the resolution code 209 to be applied for resolving the incident ticket 206. In some embodiments, the knowledge graph may be traversed to find a unique signature that matches with the signature of an incoming ticket so as to identify the resolution code, which is stored in the leaf node associated with the unique signature. Further, the knowledge module 204 renders the resolution code 209 to the incident ticket handling agent 207 via the output module 205. The incident ticket handling agent 207 executes the resolution code so as to resolve the incident ticket 206.

The signature of the incoming incident ticket 206 may be determined via a process similar to that of determining unique signature for a set of incident tickets. Thus, in some embodiments, the knowledge module 204 determines the signature for the incoming incident ticket 206 by pre-processing the descriptions of the incoming incident ticket 206, determining n-grams and corresponding weightages from the pre-processed description, and selecting one of the n-grams as the signature based on the assigned weightage.

In some embodiments, the knowledge module 204 may validate the resolution code 209 determined using the knowledge graph model with the help of a service team. For a negative validation (i.e., the resolution code not being relevant or accurate), the knowledge module 204 initiates a learning process based on intelligence gathered manual resolution of the incident ticket. The new incident ticket and the corresponding manual resolution may be provided to learning module 203 so as to update the repository and to update the knowledge graph. It should be noted that the incident ticket resulting in the negative validation is typically a new incident ticket unrelated to a plurality of past incident tickets and/or an incident ticket not having a mapped resolution. However, for a positive validation, the knowledge module 204 presents the determined resolution code to the incident ticket handling agent 207 via the output module 205.

It should be noted that the incident ticket resolution engine 200 may be implemented in programmable hardware devices such as programmable gate arrays, programmable array logic, programmable logic devices, and so forth. Alternatively, the incident ticket resolution engine 200 may be implemented in software for execution by various types of processors. An identified engine of executable code may, for instance, comprise one or more physical or logical blocks of computer instructions which may, for instance, be organized as an object, procedure, function, module, or other construct. Nevertheless, the executables of an identified engine need not be physically located together, but may comprise disparate instructions stored in different locations which, when joined logically together, comprise the engine and achieve the stated purpose of the engine. Indeed, an engine of executable code could be a single instruction, or many instructions, and may even be distributed over several different code segments, among different applications, and across several memory devices.

As will be appreciated by one skilled in the art, a variety of processes may be employed for determining a resolution for an incident ticket. For example, the exemplary system 100 and the associated incident ticket resolution engine 200 may determine relevant resolution for an incident ticket by the processes discussed herein. In particular, as will be appreciated by those of ordinary skill in the art, control logic and/or automated routines for performing the techniques and steps described herein may be implemented by the system 100 and the associated incident ticket resolution engine 200, either by hardware, software, or combinations of hardware and software. For example, suitable code may be accessed and executed by the one or more processors on the system 100 to perform some or all of the techniques described herein. Similarly, application specific integrated circuits (ASICs) configured to perform some or all of the processes described herein may be included in the one or more processors on the system 100.

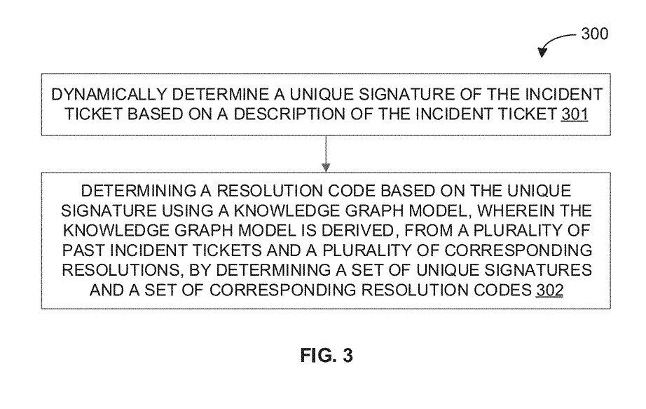

For example, referring now to FIG. 3, exemplary control logic 300 for determining a resolution for an incident ticket via a system, such as system 100, is depicted via a flowchart in accordance with some embodiments of the present disclosure. As illustrated in the flowchart, the control logic 300 includes the steps of dynamically determining a signature of the incident ticket based on a description of the incident ticket at step 301, and determining a resolution code based on the signature using a knowledge graph model at step 302. The knowledge graph model is derived, from a plurality of past incident tickets and a plurality of corresponding resolutions, by determining a set of unique signatures and a set of corresponding resolution codes. In some embodiments, the signature corresponds to a problem type in the incident ticket. Further, in some embodiments, each of the set of unique signatures corresponds to a recurring problem type in the plurality of past incident tickets.

In some embodiments, the control logic 300 may further include the steps of receiving the incident ticket from an incident ticket handling agent, and rendering the resolution, to the incident ticket handling agent for resolving the incident ticket, based on the resolution code. Additionally, in some embodiments, the control logic 300 may further include the steps of building a knowledge graph based on the plurality of past incident tickets and the plurality of corresponding resolutions, and deriving the knowledge graph model based on the knowledge graph. Further, in some embodiments, building the knowledge graph comprises determining the set of unique signatures and the set of corresponding resolution codes.

In some embodiments, dynamically determining the signature at step 301 comprises determining a plurality of n-grams and a corresponding weightage from the description based on a pre-defined value of n and a frequency of terms in the description, and selecting one of the plurality of n-grams as the signature based on the corresponding weightage.

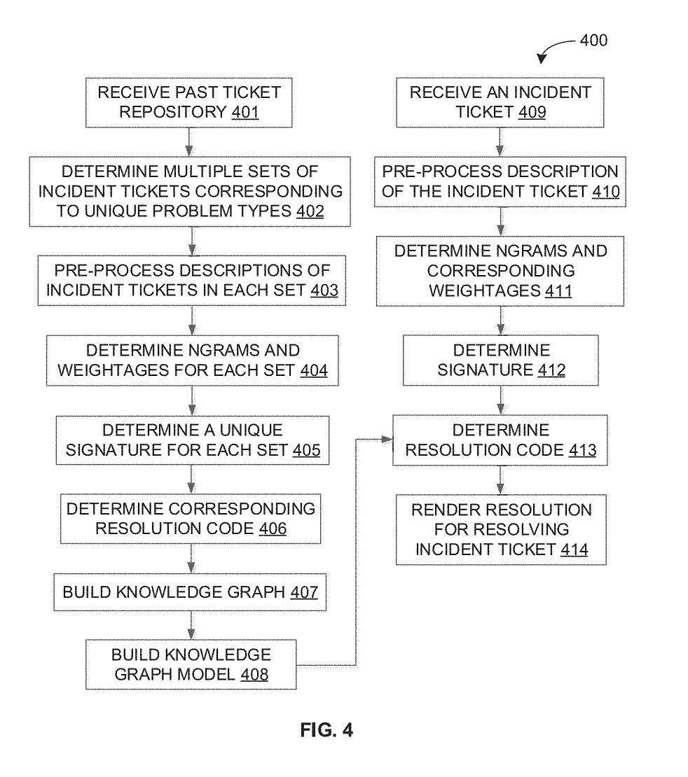

Referring now to FIG. 4, exemplary control logic 400 for determining a resolution for an incident ticket is depicted in greater detail via a flowchart in accordance with some embodiments of the present disclosure. As illustrated in the flowchart, the control logic 400 includes the steps of receiving past ticket repository comprising of past incident tickets and corresponding resolutions at step 401 and determining multiple sets of incident tickets corresponding to unique problem types at step 402. The control logic 400 further includes the steps of pre-processing descriptions of incident tickets in each of the sets at step 403, determining n-grams and corresponding weightages from the pre-processed descriptions for each of the sets at step 404, and selecting one of the n-grams, based on the assigned weightage, as the unique signature for each of the sets at step 405. The control logic 400 further includes the step of determining resolution code for each of the sets at step 406. The control logic 400 further includes the steps of building a knowledge graph by mapping the unique signature for each of the sets with corresponding resolution codes for each of the sets at step 407, and building a knowledge graph model based on the knowledge graph at step 408.

Additionally, the control logic 400 includes the steps of receiving an incident ticket from the incident ticket handling agent at step 409, pre-processing the description of the incident ticket at step 410, determining n-grams and corresponding weightage from the pre-processed description of the incident ticket at 411, and determining a signature of the incident ticket at step 412. The control logic 400 further includes the step of determining a resolution code for the incident ticket based on the signature using the knowledge graph model at step 413. It should be noted that, in some embodiments, the determination at step 413 involves comparing or matching the signature of the incident ticket with the unique signatures derived from the past incident tickets, and then looking for the resolution code corresponding to the matched unique signature. The control logic 400 further includes the step of rendering the resolution for resolving the incident ticket based on the resolution code at step 414.

As will be also appreciated, the above described techniques may take the form of computer or controller implemented processes and apparatuses for practicing those processes. The disclosure can also be embodied in the form of computer program code containing instructions embodied in tangible media, such as floppy diskettes, CD-ROMs, hard drives, or any other computer-readable storage medium, wherein, when the computer program code is loaded into and executed by a computer or controller, the computer becomes an apparatus for practicing the invention. The disclosure may also be embodied in the form of computer program code or signal, for example, whether stored in a storage medium, loaded into and/or executed by a computer or controller, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

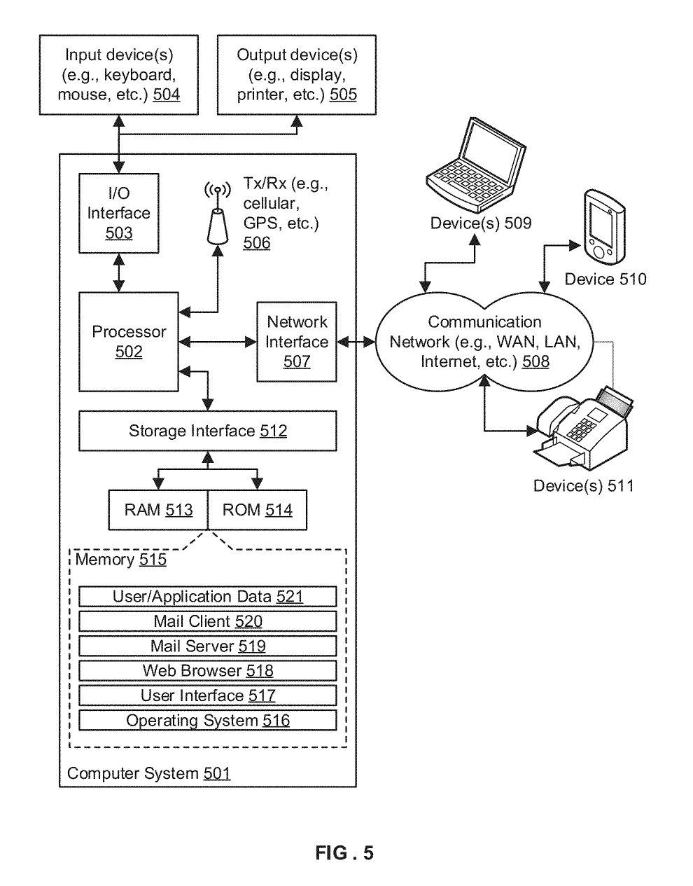

The disclosed methods and systems may be implemented on a conventional or a general-purpose computer system, such as a personal computer (PC) or server computer. Referring now to FIG. 5, a block diagram of an exemplary computer system 501 for implementing embodiments consistent with the present disclosure is illustrated. Variations of computer system 501 may be used for implementing system 100 and incident ticket resolution engine 200 for resolving incident tickets. Computer system 501 may comprise a central processing unit (“CPU” or “processor”) 502. Processor 502 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athlon, Duron or Opteron, ARM's application, embedded or secure processors, IBM PowerPC, Intel's Core, Itanium, Xeon, Celeron or other line of processors, etc. The processor 502 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 502 may be disposed in communication with one or more input/output (I/O) devices via I/O interface 503. The I/O interface 503 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n/b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 503, the computer system 501 may communicate with one or more I/O devices. For example, the input device 504 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. Output device 505 may be a printer, fax machine, video display (e.g., cathode ray tube (CRT), liquid crystal display (LCD), light-emitting diode (LED), plasma, or the like), audio speaker, etc. In some embodiments, a transceiver 506 may be disposed in connection with the processor 502. The transceiver may facilitate various types of wireless transmission or reception. For example, the transceiver may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, the processor 502 may be disposed in communication with a communication network 508 via a network interface 507. The network interface 507 may communicate with the communication network 508. The network interface may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 508 may include, without limitation, a direct interconnection, local area network (LAN), wide area network (WAN), wireless network (e.g., using Wireless Application Protocol), the Internet, etc. Using the network interface 507 and the communication network 508, the computer system 501 may communicate with devices 509, 510, and 511. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, the computer system 501 may itself embody one or more of these devices.

In some embodiments, the processor 502 may be disposed in communication with one or more memory devices (e.g., RAM 513, ROM 514, etc.) via a storage interface 512. The storage interface may connect to memory devices including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

The memory devices may store a collection of program or database components, including, without limitation, an operating system 516, user interface application 517, web browser 518, mail server 519, mail client 520, user/application data 521 (e.g., any data variables or data records discussed in this disclosure), etc. The operating system 516 may facilitate resource management and operation of the computer system 501. Examples of operating systems include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 517 may facilitate display, execution, interaction, manipulation, or operation of program components through textual or graphical facilities. For example, user interfaces may provide computer interaction interface elements on a display system operatively connected to the computer system 501, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, the computer system 501 may implement a web browser 518 stored program component. The web browser may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, the computer system 501 may implement a mail server 519 stored program component. The mail server may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, the computer system 501 may implement a mail client 520 stored program component. The mail client may be a mail viewing application, such as Apple Mail, Microsoft Entourage, Microsoft Outlook, Mozilla Thunderbird, etc.

In some embodiments, computer system 501 may store user/application data 521, such as the data, variables, records, etc. (e.g., past ticket repository, incident tickets, resolution codes, n-grams, unique signatures, knowledge graph, knowledge graph model, signature, and so forth) as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

As will be appreciated by those skilled in the art, the techniques described in the various embodiments discussed above result in automated, efficient, and speedy resolution of incident tickets, thereby reducing the manual effort and the time delay in providing accurate resolution. For example, the techniques described above provide for a semi-supervised learning model so as to auto-resolve semi-structured system generated incidents. Further, the techniques described in the embodiments discussed above increase the productivity of the user as well as the resolution team handling those tickets. The user can have quick resolution to his query while the resolution team may focus on new issues for which there are no mapped resolutions.

Further, as will be appreciated by those skilled in the art, the techniques described above does not require storing the activity data of past incident tickets, and does not need manual analysis for identification of resolution code. The techniques therefore enable determination of the resolution code of an incoming ticket in a space and time efficient manner.

Additionally, the techniques described in the various embodiments discussed above dynamically generates a signature for the incoming ticket in an unsupervised manner to decide upon the resolution code to be applied using a knowledge graph model. Additionally, the techniques in the various embodiments discussed above builds a knowledge graph model by generating a unique signature for each unique type of a problem being addressed in the tickets in an unsupervised manner, and associating each of the unique signature with an appropriate resolution code to be applied so as to identify the type of resolution. Thus, the techniques described above identify the resolution code for an incoming ticket instead of the commands to be performed for automatic resolution of the same.

The specification has described system and method for resolving incident tickets. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for determining a resolution for an incident ticket, the method comprising:
dynamically determining, via an incident ticket resolution engine, a signature of the incident ticket based on a description of the incident ticket; and
determining, via the incident ticket resolution engine, a resolution code based on the signature using a knowledge graph model, wherein the knowledge graph model is derived, from a plurality of past incident tickets and a plurality of corresponding resolutions, by determining a set of unique signatures and a set of corresponding resolution codes.

2. The method of claim 1, further comprising:
receiving the incident ticket from an incident ticket handling agent; and
rendering the resolution, to the incident ticket handling agent for resolving the incident ticket, based on the resolution code.

3. The method of claim 1, wherein the signature corresponds to a problem type in the incident ticket.

4. The method of claim 1, wherein dynamically determining the signature comprises:
determining a plurality of n-grams and a corresponding weightage from the description based on a pre-defined value of n and a frequency of terms in the description; and
selecting one of the plurality of n-grams as the signature based on the corresponding weightage

5. The method of claim 1, wherein each of the set of unique signatures corresponds to a recurring problem type in the plurality of past incident tickets.

6. The method of claim 1, wherein further comprising:
building a knowledge graph based on the plurality of past incident tickets and the plurality of corresponding resolutions; and
deriving the knowledge graph model based on the knowledge graph.

7. The method of claim 6, wherein building the knowledge graph comprises determining the set of unique signatures and the set of corresponding resolution codes.

8. A system for determining a resolution for an incident ticket, the system comprising:
at least one processor; and
a computer-readable medium storing instructions that, when executed by the at least one processor, cause the at least one processor to perform operations comprising:
dynamically determining a signature of the incident ticket based on a description of the incident ticket; and
determining a resolution code based on the signature using a knowledge graph model, wherein the knowledge graph model is derived, from a plurality of past incident tickets and a plurality of corresponding resolutions, by determining a set of unique signatures and a set of corresponding resolution codes.

9. The system of claim 8, wherein the operations further comprise:
receiving the incident ticket from an incident ticket handling agent; and
rendering the resolution, to the incident ticket handling agent for resolving the incident ticket, based on the resolution code.

10. The system of claim 8, wherein dynamically determining the signature comprises:
determining a plurality of n-grams and a corresponding weightage from the description based on a pre-defined value of n and a frequency of terms in the description; and
selecting one of the plurality of n-grams as the signature based on the corresponding weightage.

11. The system of claim 8, wherein the signature corresponds to a problem type in the incident ticket, and wherein each of the set of unique signatures corresponds to a recurring problem type in the plurality of past incident tickets.

12. The system of claim 8, wherein the operations further comprise:
building a knowledge graph based on the plurality of past incident tickets and the plurality of corresponding resolutions; and
deriving the knowledge graph model based on the knowledge graph.

13. The system of claim 12, wherein building the knowledge graph comprises determining the set of unique signatures and the set of corresponding resolution codes.

14. A non-transitory computer-readable storage medium having stored thereon, a set of computer-executable instructions for causing a computer comprising one or more processors to perform steps comprising:
dynamically determining a signature of the incident ticket based on a description of the incident ticket; and
determining a resolution code based on the signature using a knowledge graph model, wherein the knowledge graph model is derived, from a plurality of past incident tickets and a plurality of corresponding resolutions, by determining a set of unique signatures and a set of corresponding resolution codes.

15. The non-transitory computer-readable storage medium of claim 14, wherein the steps further comprise:
receiving the incident ticket from an incident ticket handling agent; and
rendering the resolution, to the incident ticket handling agent for resolving the incident ticket, based on the resolution code.

16. The non-transitory computer-readable storage medium of claim 14, wherein dynamically determining the signature comprises:
determining a plurality of n-grams and a corresponding weightage from the description based on a pre-defined value of n and a frequency of terms in the description; and
selecting one of the plurality of n-grams as the signature based on the corresponding weightage.

17. The non-transitory computer-readable storage medium of claim 14, wherein the signature corresponds to a problem type in the incident ticket, and wherein each of the set of unique signatures corresponds to a recurring problem type in the plurality of past incident tickets.

18. The non-transitory computer-readable storage medium of claim 14, wherein the steps further comprise:
building a knowledge graph based on the plurality of past incident tickets and the plurality of corresponding resolutions; and
deriving the knowledge graph model based on the knowledge graph.

19. The non-transitory computer-readable storage medium of claim 18, wherein building the knowledge graph comprises determining the set of unique signatures and the set of corresponding resolution codes.
